(19) United States
(12) Patent Application Publication
(10) Pub. No.: US 2025/0217494 A1
(43) Pub. Date: Jul. 3, 2025

(54) SYSTEM AND METHOD FOR ONLINE BLACKBOX ADVERSARIAL ATTACK IN PHYSICAL WORLD

(71) Applicant: Robert Bosch GmbH, Stuttgart (DE)

(72) Inventors: Monikasrivyshnavi Nagalla, Pittsburgh, PA (US); João D. Semedo, Pittsburgh, PA (US); Wan-Yi Lin, Wexford, PA (US); FILIPE J. CABRITA CONDESSA, Pittsburgh, PA (US)

(21) Appl. No.: 18/400,169

(22) Filed: Dec. 29, 2023

(51) Int. Cl. G06F 21/57

(52) U.S. Cl. CPC G06F 21/577; G06F 2221/033

(57) ABSTRACT

A computer-implemented method for attacking a machine-learning model, comprising establishing a connection between a processor that is utilizing the machine-learning model, wherein the processor is in communication with a sensor located in a physical scene, outputting on a display device in the physical scene, an adversarial pattern, wherein the display device including the adversarial pattern is located in a sensor range of the sensor, obtaining, from the machine-learning model, a classification associated with the physical scene that includes the adversarial pattern, determining if a target classification has been met with a classification output from the machine-learning model, and in response to the target classification not being met, output additional adversarial patterns at the display device and repeat steps until the target classification has been met.

### TECHNICAL FIELD

The present disclosure relates to machine learning networks, including those as related to adversarial attacks.

### BACKGROUND

Physically realizable black-box attacks modifies the scene, or the path between the scene and the camera, by placing an adversarial object without knowledge of the model. Such adversarial objects may represent a realistic threat model for safety-critical applications, such as autonomous driving. Typically, physically-realizable attacks focus on creating the adversarial object beforehand, by using a set of data captured from clean scenes for training. However, the effectiveness of such adversarial objects heavily depends on the quality of the training data, and the trained adversarial object may or may not be effective for the attack scene. On the other hand, other systems propose generating blackbox attacks on the fly by querying an existing classification API. However such an attack is in digital (image) domain, not in the physical world. Other systems may propose an efficient algorithm for physically-realizable attacks, yet how to practically set up the attack system was not addressed.

### SUMMARY

A first embodiment discloses a computer-implemented method for attacking a machine-learning model, comprising establishing a connection between a processor that is utilizing the machine-learning model, wherein the processor is in communication with a sensor located in a physical scene, outputting on a display device in the physical scene, an adversarial pattern, wherein the display device including the adversarial pattern is located in a sensor range of the sensor, obtaining, from the machine-learning model, a classification associated with the physical scene that includes the adversarial pattern, determining if a target classification has been met with a classification output from the machine-learning model, and in response to the target classification not being met, output additional adversarial patterns at the display device and repeat steps until the target classification has been met.

A second embodiment discloses a computer-implemented method for attacking a machine-learning model that includes establishing a connection between a processor that is utilizing the machine-learning model, wherein the processor is in communication with a sensor located in a scene, outputting, on a speaker located in the physical scene, an adversarial acoustic pattern, wherein the speaker that outputs the adversarial acoustic pattern is located in a sensor range of the sensor, obtaining, from the machine-learning model, a classification associated with the scene that includes the adversarial acoustic pattern, determining if a target classification has been met with a classification output from the machine-learning model, and in response to the target classification not being met, outputting additional adversarial acoustic patterns at the speaker and repeating the obtaining and determining steps until the target classification has been met.

A third embodiment discloses a system that includes an attack for a machine-learning network that includes a sensor, wherein the sensor includes either a camera, a microphone, a radar, a LiDar, or any combination thereof, a display device located in the physical scene and configured to output one or more images, one or more processors in communication with the sensor and the display device, wherein the one or more processors are collectively programmed to establish a connection with a machine-learning model, output on the display device, an adversarial pattern, wherein the display device including the adversarial pattern is located in a sensor range of the sensor, obtain, from the machine-learning model, a classification associated with the physical scene that includes the adversarial pattern, wherein the classification is associated with both the sensor and the machine-learning model, determine if a target classification has been met with the classification output from the machine-learning model, and in response to the target classification not being met, output additional adversarial patterns at the display device and repeat the obtaining and determining steps until the target classification has been met.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 illustrates an example of a scene including an adversarial attack.

FIG. 4 illustrates a flow chart associated with an embodiment of the present disclosure.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The system and methods described below propose a system to physically deploy online blackbox attacks. Unlike methods that requires training data to generate attacks, this system generates attacks on the fly, which may be specifically tailored to the scene. Thus, the embodiments disclose below may not utilize training data. The system may utilize a display device, which can be a monitor, a tablet, or a cell phone as long as the patterns displayed on the device can be updated, to display the adversarial pattern in the scene. This may be different from prior art system where such systems may attack a given image and not a physical scene. In another embodiment, a speaker may output an adversarial sound.

Deep learning image models have shown state-of-the-art performance on many tasks including classification, dense prediction, and regression. However, these models are known to be brittle, where a small perturbation in the input space can cause false predictions. Such perturbations may be called adversarial attacks. Translating these small perturbations of the input image to the physical world entails creating an adversarial object placed in the scene and captured by the camera, which can cause erroneous predictions of a machine learning model applied to the images collected by the camera. The most realistic way to create such objects may be a hard-label blackbox attack which has access only to the output or loss of the model for a given input, not the model weights or parameters.

Existing work on physically realizable blackbox attacks focuses on algorithms that may update the attack, but not on the physical framework on deploying and querying the ML system. An illustrative embodiment may aim to realize such physical attacks.

This disclosure may be used to test safety critical ML systems such as autonomous driving systems before deployment. Since no training data is required for generating the attack, this invention can provide a fast worst-case performance and shorten development cycles.

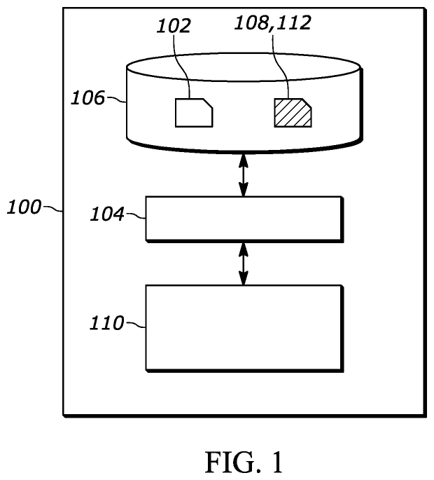

Reference is now made to the embodiments illustrated in the Figures, which can apply these teachings to a machine learning model or neural network. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

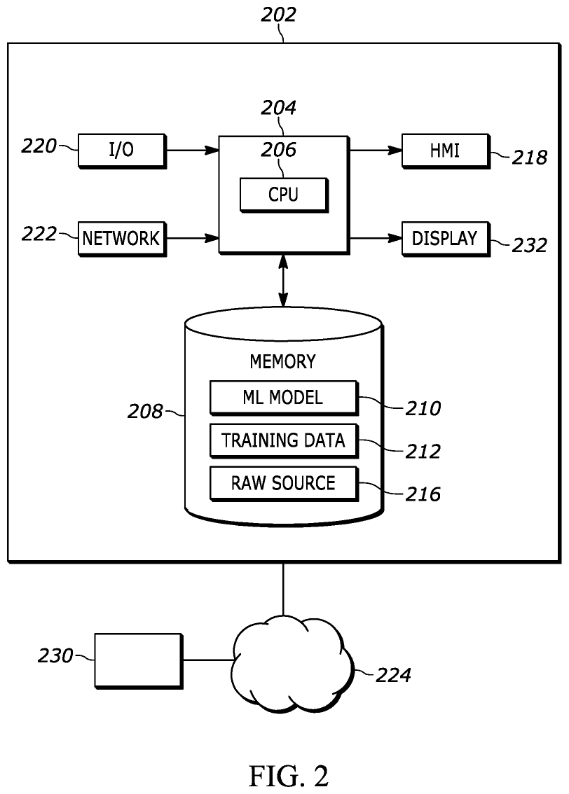

The structure of the system 100 is one example of a system that may be utilized to train the image-to-image machine-learning model and the mixer machine-learning model described herein. Additional structure for operating and training the machine-learning models is shown in FIG. 2.

FIG. 2 depicts a system 200 to implement the machine-learning models described herein, for example the image-to-image machine-learning model, the mixer machine-learning model, and the pre-trained reference model described herein. The system 200 can be implemented to perform image quantization processes described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines: timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

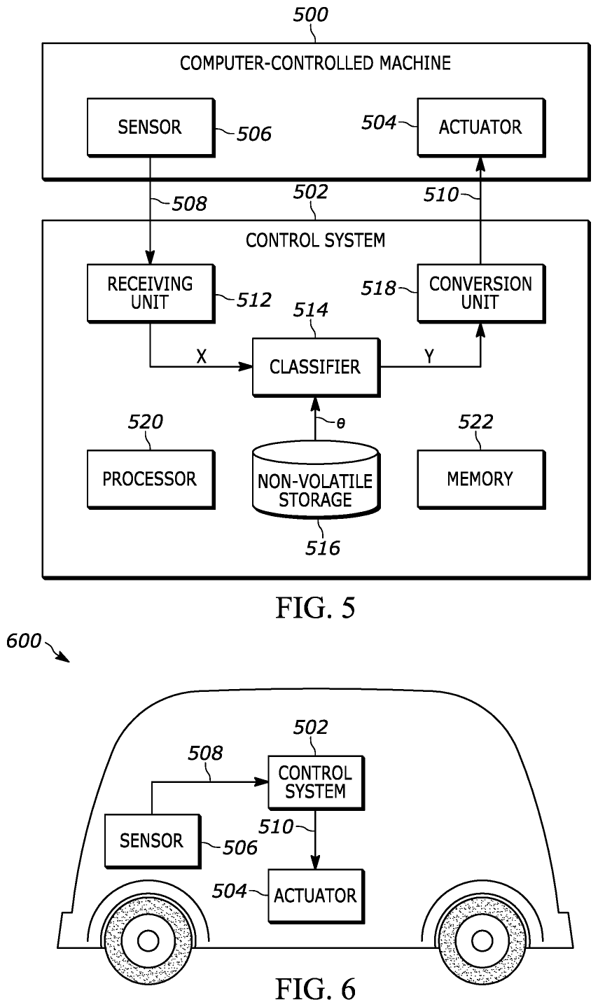

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). Several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate the image-to-image machine-learning model, the mixer machine-learning model, and the pre-trained reference model described herein.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign). The input images may include various scenarios in which the objects are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a road sign in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., road sign). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

In an example, the raw source data 216 may include image data representing an image. Applying the machine-learning algorithms (e.g., image-to-image machine learning model, mixer machine-learning model, and pre-trained reference model) described herein, the output can be a quantized version of the input image.

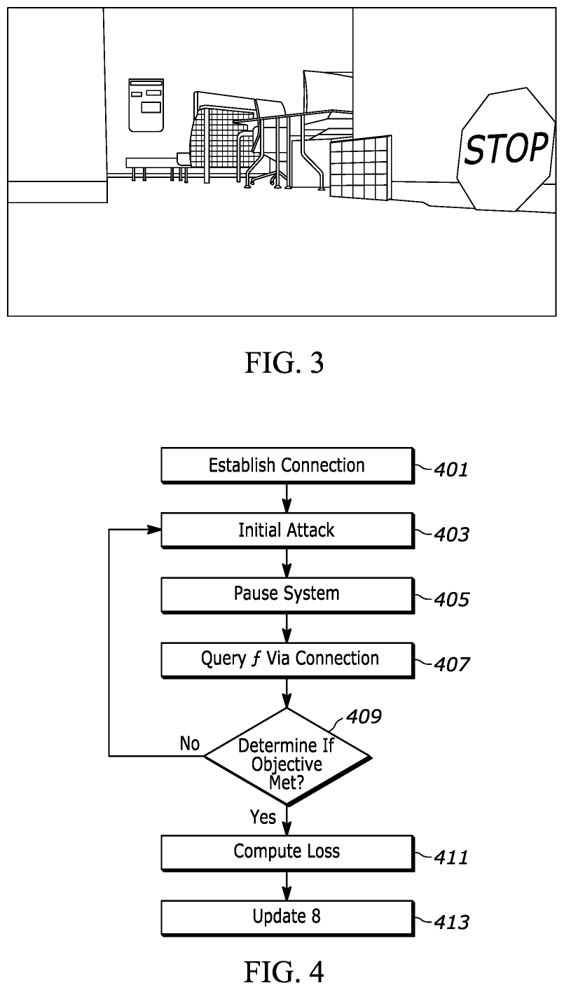

FIG. 3 illustrates an example of a rendered scene that may include a blackbox attack. In such a illustration, the system may consider the scenario that the blackbox attack B is being displayed by a display device M 301 that may be placed in a fixed place in the scene S. This scene can then be represented as S+M(δ) where M is the display device 301 with the blackbox attack δ being displayed. The blackbox attack may be a BayesOpt attack in one embodiment. Let f: R^{dim_input}→y be the machine learning (ML) model, A be the rendering function used by the renderer, l(·, ·) be the attacker-defined loss function, and g(l(·, ·)) be the blackbox attack algorithm that generates the attack δ. For targeted attacks with target T, the loss function takes as input the output of the model and T. For untargeted attacks, the loss function takes as input the output of the model and the output of the model when no adversarial pattern or benign pattern was displayed.

The various embodiments may apply to different ML tasks, such as regression, dense prediction, and sparse prediction. The input image to the machine learning model can be represented as A(S+M(δ)), and the corresponding output of the ML model is f(A(S+M(δ))). An example rendered scene with attack, A(S+M(δ)) may be shown in FIG. 3 with an adversarial pattern being shown in display device 301.

Note that the display device M, the renderer A 307, ML model f 305, its input space R^{dim_input} and the output space of attack algorithm g (i.e., δ) have paired properties-if the renderer is a camera then M is a monitor, f can be any model that takes an image within space R^{h×w×c} as input, and δ∈[0,1]^{h}^{ₐ}^{×w}^{ₐ}^{×c} where ha and wₐ are the height and width of the adversarial pattern as shown on the monitor or display. Similarly, if the renderer is in an acoustic sensor, then M is a speaker, f can be any model that takes audio within space R^{w×c} as an input, and δ∈[0,1]^{w}^{ₐ}^{×c}^{ₐ} where wₐ and cₐ are the length and number of channels of the adversarial acoustic signal, respectively. Thus, when various iterations are ran with new adversarial acoustic signals, the system may change the length and number of channels associated with each iteration.

There may be various devices utilized for the attack. In one embodiment, the display device M may be utilized. In another embodiment, there may also be a compute device that is equipped with a compute capability for running a blackbox attack algorithm g. The compute device may also include communication capability for querying model f remotely. In one example if the machine learning (ML) model is being used as part of a robotics application, the output of the model may often be transmitted to other components of the system, and might therefore be published as a Robotics Operating System. If the compute device can subscribe to this topic it can effectively query the ML model. In another example, if the ML model's output is used to drive any type of actuator, the compute device can estimate the ML model's output using a camera system monitoring the actuator.

There may be various objectives for an attack. In one scenario for targeted attacks, the objective is to make the output of the model be a specified target T, e.g., f(A(S+M(δ)))=T. In another scenario for untargeted attack, the objective may be to change the output of the model, i.e., f(A(S+M(δ)))≠f(S). In certain cases, such as regression, detection, segmentation, and recognition, the untargeted attack would aim to change the output of the model at least a certain amount, i.e., diff(f(A(S+M(δ))), f(S))>=threshold, where diff(·, ·) is a difference measurement of the output of model f. The processor may be programmed to have access to the target classification and output of the model, thus it can be determined the differential. The target classification may be the class of object that the attacker set beforehand. In an autonomous driving scenario, target class can be any class of objects that is safe to run over, such as zebra crossing, lane marking, or a plastic bag.

The system may have additional inputs based on various embodiments. The additional input may be time between displaying updated adversarial attack and next query (K seconds). The value K may depend on the renderer. For example, if the renderer can move (e.g. cameras on an autonomous car), then K should be a smaller value. Thus the pause can be a smaller time period. However, for a static render, the pause time can be as long as a couple seconds. Furthermore, the system may define via an input the maximum number of queries.

FIG. 4 illustrates a flow chart associated with an attack according to an embodiment. The steps for initiated the attack on a scene may be outlined as discussed below. At step 401, the system may establish a connection between compute device and the model f. The compute device may include a processor, memory, and other storage components that include a machine learning model f. The connection may be a wireless connection or a wired connection. Wireless connections may include a Wi-Fi connection, Bluetooth connection, or any other type of connection. The connection may not have access to the model, as it may be a black-box attack that is implemented utilizing an adversarial pattern.

At step 403, the system may establish at an output device (e.g., such as a display, monitor, speaker, etc.) an initial attack & on display device (e.g., output device) M. The initial attack may be an adversarial pattern that may be a RBG image that is output on a monitor in one scenario. In another scenario, the adversarial pattern may be an adversarial acoustic pattern. As discussed, various adversarial patterns may be output at the display device in order to identify a machine learning models of handling targeted attacks and untargeted attacks.

At step 405, the system may pause for a given threshold or timeline. For example, the system may pause for K seconds in a certain scenario. The timeline may be any duration, such as a time in the milliseconds, nanoseconds, seconds, minutes, etc. The pause threshold may change depending on whether or not the renderer is moving or static.

At step 407, the system may query f via connection to obtain output f(A(S+M(δ))). Thus, the system may query as to what classification has been obtained by the scene with the associated adversarial pattern produced on the monitor. The system may determine what the machine learning model has classified as the scene associated with the adversarial pattern. When the output of f cannot be obtained by queries, in some scenarios it may be observed. For example, the steering wheel angle of autonomous driving cars can be observed via the trajectory or car wheel angle, without direct connection to the autonomous driving model.

At decision 409, the system may determine if the attack objectives is met. The attack objectives may include a threshold percentage of misclassification, classification error, number of iterations, etc. If the system has determined that there has been a successful attack, it may stop after a first iteration. If not, the system may continue to perform other steps.

At step 411, the system may compute loss/that has occurred based on the adversarial attack. The system may compare the classification attributed to the scene (absent the adversarial attack) and compare that to the classification of the scene utilizing the adversarial attack, in one instance.

At step 413, the system may update δ using the output of blackbox attack algorithm: g(l)→δ and display on the device M. The system may repeat steps 405 to 411 until a maximum number of queries has been met, or another threshold. For example, a loss threshold may need to be reached or exceeded before the blackbox attack algorithm completes outputting adversarial patterns. As such, the data may be collected at each step of the way to identify the classifications and adversarial patterns utilize. Thus, such data may be useful in testing physical attacks in a real-world environment to make improvements to a machine learning model.

The machine-learning models described herein can be used in many different applications, and not just in the context of road sign image processing. Additional applications where image quantization may be used are shown in FIGS. 6-11. Structure used for training and using the machine-learning models for these applications (and other applications) are exemplified in FIG. 5. FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above with regard to pre-trained classifier 306) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. In the context of sign-recognition and processing as described herein, the sensor 506 is a camera mounted to or integrated into the vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

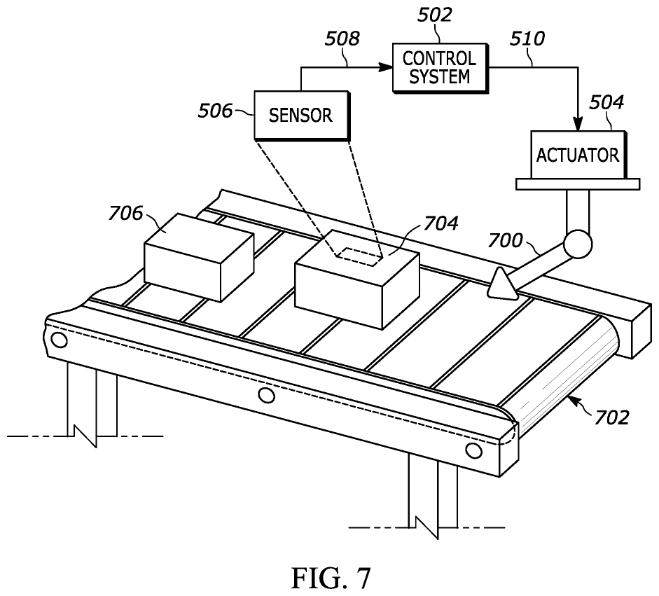

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 106 of system 700 (e.g., manufacturing machine) depending on the determined state of manufactured product 704.

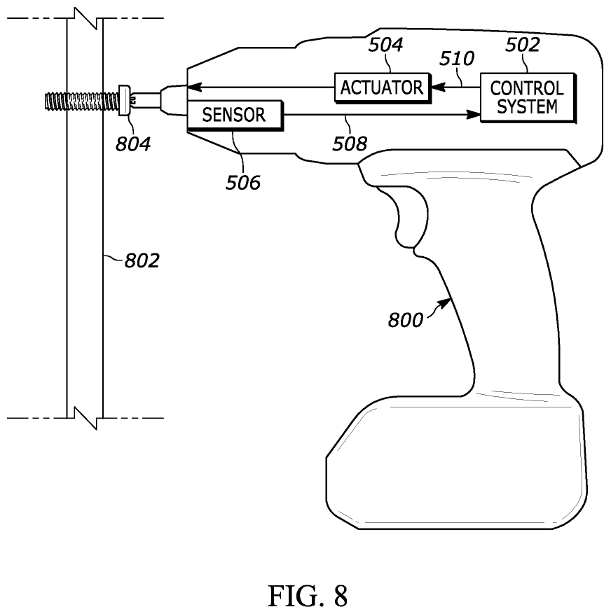

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

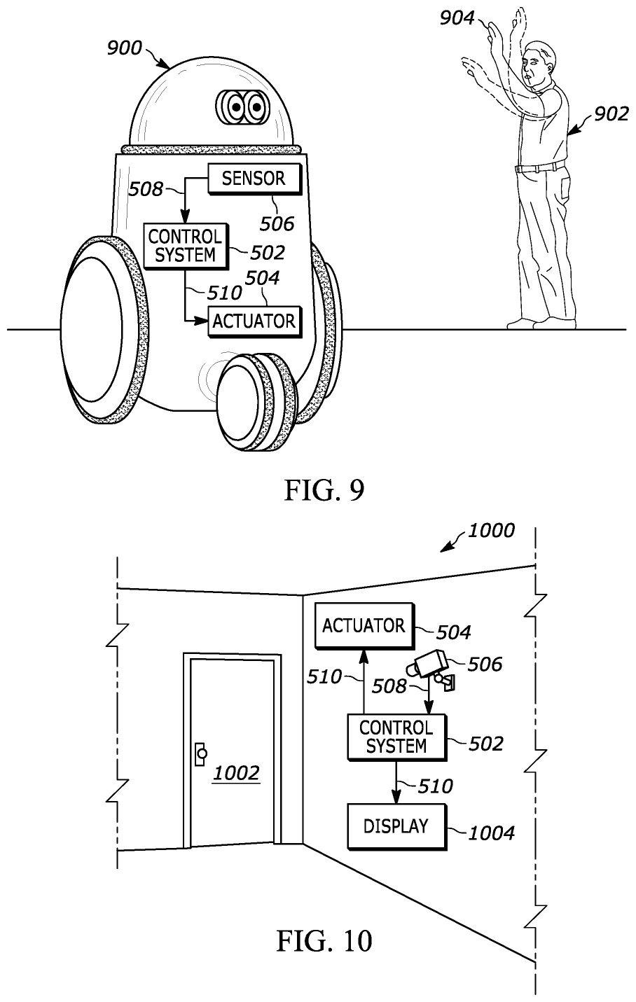

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

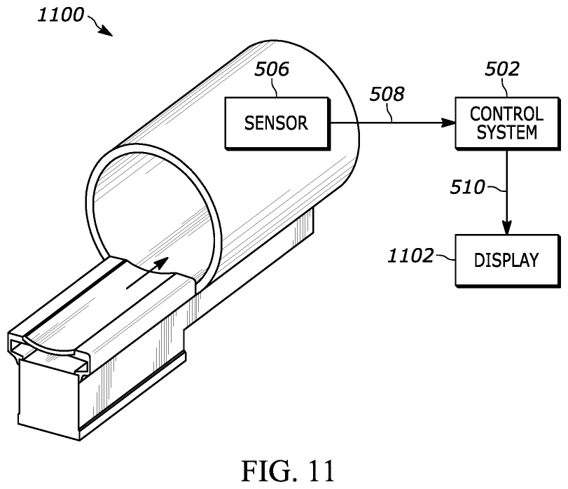

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for attacking a machine-learning model, comprising:
(i) establishing a connection between a processor that is utilizing the machine-learning model, wherein the processor is in communication with a sensor located in a physical scene;
(ii) outputting, on a display device in the physical scene, an adversarial pattern, wherein the display device including the adversarial pattern is located in a sensor range of the sensor;
(iii) obtaining, from the machine-learning model, a classification associated with the physical scene that includes the adversarial pattern;
(iv) determining if a target classification has been met with a classification output from the machine-learning model;
(v) in response to the target classification not being met, outputting additional adversarial patterns at the display device and repeat steps (iii) through (iv) until the target classification has been met.

2. The computer-implemented method of claim 1, wherein the adversarial pattern is a red-green-blue image.

3. The computer-implemented method of claim 1, update the adversarial pattern with Bayesian optimization utilizing the objective function.

4. The computer-implemented method of claim 1, wherein the method includes adding a pause for a threshold pause time period after step (ii).

5. The computer-implemented method of claim 4, wherein the pause time period is dependent on whether a renderer is moving or static.

6. The computer-implemented method of claim 1, wherein the processor is programmed to not have knowledge of weights or parameters associated with the machine learning model.

7. The computer-implemented method of claim 1, wherein the adversarial pattern is located on a display, monitor, or speaker in a scene within the sensor range.

8. The computer-implement method of claim 1, wherein the target classification includes a loss differential between the classification and the target classification indicating a class of the object established by an attacker.

9. The computer-implemented method of claim 1, wherein the processor is programmed to only have access to an output or loss of the machine-learning model for a given input associated with the machine-learning model.

10. A computer-implemented method for attacking a machine-learning model, comprising:
(i) establishing a connection between a processor that is utilizing the machine-learning model, wherein the processor is in communication with a sensor located in a scene;
(ii) outputting, on a speaker located in the physical scene, an adversarial acoustic pattern, wherein the speaker that outputs the adversarial acoustic pattern is located in a sensor range of the sensor;
(iii) obtaining, from the machine-learning model, a classification associated with the scene that includes the adversarial acoustic pattern;
(iv) determining if a target classification has been met with a classification output from the machine-learning model;
(v) in response to the target classification not being met, outputting additional adversarial acoustic patterns at the speaker and repeat steps (iii) through (iv) until the target classification has been met.

11. The computer-implemented method of claim 10, wherein the adversarial acoustic pattern includes a length and number of channels associated that change with each iteration of one of the plurality of adversarial acoustic patterns.

12. The computer-implemented method of claim 10, wherein the method includes not accessing training data associated with the machine-learning model.

13. A system including an attack for a machine-learning network, comprising:
a sensor, wherein the sensor includes either a camera, a microphone, a radar, a LiDar, or any combination thereof;
a display device located in the physical scene and configured to output one or more images;
one or more processors in communication with the sensor and the display device, wherein the one or more processors are collectively programmed to:
(i) establish a connection with a machine-learning model;
(ii) output, on the display device, an adversarial pattern, wherein the display device including the adversarial pattern is located in a sensor range of the sensor:
(iii) obtain, from the machine-learning model, a classification associated with the physical scene that includes the adversarial pattern, wherein the classification is associated with both the sensor and the machine-learning model;
(iv) determine if a target classification has been met with the classification output from the machine-learning model;
(v) in response to the target classification not being met, output additional adversarial patterns at the display device and repeat steps (iii) through (iv) until the target classification has been met.

14. The system of claim 13, wherein the one or more processors are programmed to not have access to parameters or weights associated with the machine-learning model.

15. The system of claim 13, wherein the adversarial pattern is an acoustic signal and the sensor is the microphone.

16. The system of claim 13, wherein the adversarial pattern is an RGB image and the sensor is the camera.

17. The system of claim 16, wherein the RGB image includes video.

18. The system of claim 13, wherein the one or more processors are collectively programmed to pause for a pause period prior to obtaining the classification.

19. The system of claim 13, wherein the one or more processors are programmed to create the adversarial pattern utilizing a black-box algorithm.

20. The system of claim 13, wherein the adversarial pattern is generated to facilitate in regression, detection, segmentation, and recognition.
